(19) United States
(12) Patent Application Publication
(10) Pub. No.: US 2002/0140010 A1
(43) Pub. Date: Oct. 3, 2002

(54) Imaging system

(76) Inventors: Truc Q. Vu, Tustin, CA (US); Frank Calabretta, Costa Mesa, CA (US); James F. Asbrock, Oceanside, CA (US); Nhan T. Do, San Jose, CA (US)

Correspondence Address: Leonard A. Alkov, Esq., Raytheon Company, P.O. Box 902 (E1/E150), El Segundo, CA, 90245-0902, US

(21) Appl. No.: 09/821,320

(22) Filed: Mar. 29, 2001

(51) Int. Cl. H04N 5/335

(52) U.S. Cl. 257/294; 348/294

(57) ABSTRACT

A detector with a transistor sensitive to electromagnetic energy. In accordance with the present teachings, the transistor is biased such that the output thereof is responsive to the electromagnetic energy. The inventive imager includes an array of the novel detectors. Each of the detectors being an n-channel metal-oxide semiconductor transistor with a floating body. The transistors are biased for selective activation and sequential readout. The transistor outputs are read by a differential current sense amplifier. A color filter is disclosed to provide a color sense capability. As an alternative, a grating is provided for this purpose. The present invention allows a very dense imager to be built on using conventional silicon on sapphire or silicon on insulator complementary metal-oxide semiconductor processes. The use of standard CMOS processes allows for low manufacturing costs.

### BACKGROUND OF THE INVENTION

1. Field of the Invention

The present invention relates to imaging systems. More specifically, the present invention relates to digital imaging systems operative in the visible portion of the electromagnetic spectrum.

2. Description of the Related Art

Imaging systems are well known in the art. These devices are used in cameras and detectors to provide an image of a scene or object for display or output purposes. Imaging systems are operative over various portions of the electromagnetic spectrum and at various intensity levels. For consumer, commercial, industrial and military applications, imaging systems operative in the visible portion of the electromagnetic spectrum are of particular utility.

Existing imagers are typically implemented either with charge-coupled device (CCD) type technology or complementary metal-oxide semiconductor (CMOS) type technology. The CCD imager requires a high (e.g., 100%) yield of CCD elements. Accordingly, a high manufacturing cost is associated with CCD imagers. In addition, the size of the CCD array is typically limited by the charge transfer efficiency of the device and the power dissipation is typically relatively high for many applications.

The CMOS imager uses diodes as photo-detectors. Unfortunately, the photocurrent level of photodetectors is characteristically low. Accordingly, high gain amplifiers are typically required to readout and amplify the sensed signals. The amplifiers and associated readout circuitry add significantly to the size and cost of the device.

Cost is problematic for obvious reasons. Size is problematic inasmuch as the size of the detector determines the maximum potential detector density for a given area or volume. For a given area, the density of the detectors determines the maximum screen size or the maximum resolution of the imager with respect to a specified screen size.

Hence, a need exists in the art for a system or method for imaging in the visible spectrum with high detector density at low cost.

### SUMMARY OF THE INVENTION

The need in the art is addressed by the detector of the present invention. The inventive detector is implemented with a transistor sensitive to electromagnetic energy. In accordance with the present teachings, the transistor is biased such that the output thereof is responsive to the electromagnetic energy.

The present teachings enable a novel and advantageous imager. The inventive imager includes an array of detectors. Each of the detectors being an n-channel metal-oxide semiconductor transistor with a floating body. The transistors are biased for selective activation and sequential readout. The transistor outputs are read by a differential current sense amplifier. A color filter is disclosed to provide a color sense capability. As an alternative, a grating is provided for this purpose.

The present invention allows a very dense imager to be built on using conventional silicon on sapphire (SOS) or silicon on insulator (SOI) complementary metal-oxide semiconductor (CMOS) processes. The use of standard CMOS processes allows for low manufacturing costs. The use of SiGe on SOS/SOI will extend the detecting wavelength to the near infrared region. The ROM-like structure of the imager will provide a very low power operation, which provides a competitive advantage in portable electronics applications.

### BRIEF DESCRIPTION OF THE DRAWINGS

FIG. 1 is a schematic diagram of an illustrative implementation of a digital imaging system implemented in accordance with the teachings of the present invention.

FIG. 2 is a graph illustrating the drain current of a silicon on sapphire or silicon on insulator n-channel metal-oxide semiconductor transistor with a high gate to source voltage applied thereto.

FIG. 3 is a sectional side view showing a portion of the detector array of the imaging system of the present invention on a physical substrate with a color filter thereon.

FIG. 4 is a sectional side view of an alternative arrangement for effecting color filtering using a diffractive grating.

### DESCRIPTION OF THE INVENTION

Illustrative embodiments and exemplary applications will now be described with reference to the accompanying drawings to disclose the advantageous teachings of the present invention.

While the present invention is described herein with reference to illustrative embodiments for particular applications, it should be understood that the invention is not limited thereto. Those having ordinary skill in the art and access to the teachings provided herein will recognize additional modifications, applications, and embodiments within the scope thereof and additional fields in which the present invention would be of significant utility.

FIG. 1 is a schematic diagram of an illustrative implementation of a digital imaging system implemented in accordance with the teachings of the present invention. The inventive imager 11 includes an array 13 of detector elements of which a single row is shown with three transistors Q1, Q2 and Q3. Those skilled in the art will appreciate that he number of transistors in each row and the number of rows and columns in the array will vary depending on the application and the resulting array would be encompassed within the scope of the present teachings.

In accordance with the present teachings, each detector element is implemented with a transistor sensitive to electromagnetic radiation in the wavelength of interest. In the illustrative embodiment, the detector elements are implemented with body floating, n-channel metal-oxide semiconductor (NMOS) silicon on sapphire (SOS) or silicon on insulator (SOI) transistors. Those skilled in the art will appreciate that other technologies may be used without departing from the scope of the present teachings.

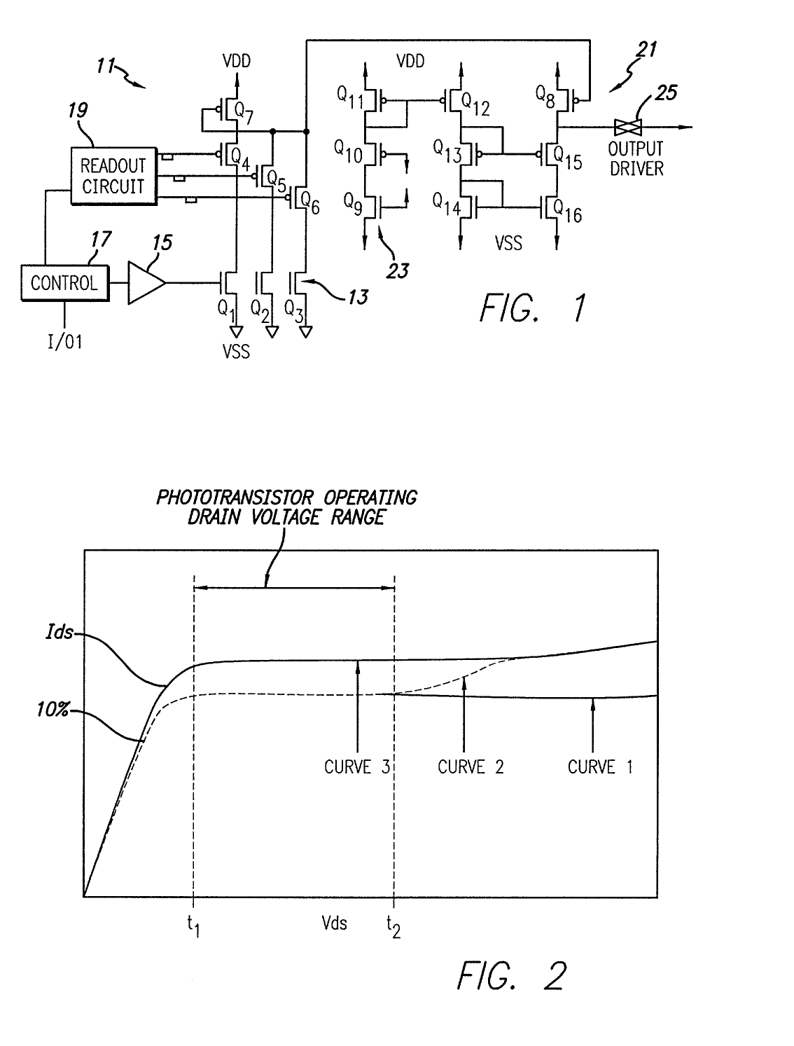

The detector elements are biased to provide the desired sensitivity in the region of interest. Photo-generated current charges up the body of the transistor thus increasing its output current. That is, photo-generated current in the body of the transistor causes the potential of the body to increase thus decreasing the threshold voltage of the transistor. Transistor drain current is increased due to lower threshold voltage. In accordance with the present teachings, the resulting increase in drain current is sensed by a differential sensing circuit. This is discussed more fully below with initial reference to FIG. 2.

FIG. 2 is a graph illustrating the drain current of a silicon on sapphire or silicon on insulator n-channel metal-oxide semiconductor transistor with a high gate to source voltage (V_{gs}) applied thereto. In FIG. 2, curve 1 shows a current versus voltage (i/v) characteristic of a typical silicon on sapphire or silicon on insulator n-channel metal-oxide semiconductor transistor with a body tied to the source terminal thereof. Curve 2 shows the characteristic of the device with the body floating and dark and curve 3 shows the characteristic of the device with the body floating and under illumination. Note that under illumination, the output current of a silicon on sapphire or silicon on insulator n-channel metal-oxide semiconductor transistor device with a floating body is substantially higher over the operating range thereof for the same applied voltage.

Returning to FIG. 1, in accordance with the present teachings, a buffer amplifier 15 supplies the high gate to source voltage required under command of a controller 17. The controller 17 may be implemented with a microprocessor and imager control software of conventional design. First, second and third P-channel metal-oxide semiconductor (PMOS) transistors Q4, Q5 and Q6 are connected between the drain terminals of transistors Q1, Q2 and Q3, respectively, and the source of a fourth PMOS transistor Q7. The drain of Q7 is connected to a source of supply while the gate thereof is connected to the source thereof. In this configuration, Q7 provides a load resistance for the transistors Q1, Q2 and Q3. The supply voltages V_{DD} and V_{SS}, the load resistor Q7 and the sizes of the transistors Q4, Q5 and Q6 are chosen to ensure that the transistors Q4, Q5 and Q6 are biased into the photo-transistor drain voltage operating range depicted in FIG. 2.

First, second and third P-channel metal-oxide semiconductor (PMOS) transistors Q4, Q5 and Q6 are driven by a conventional readout circuit 19 under command of the imager controller 17. The drain terminals of the first, second and third PMOS transistors Q4, Q5 and Q6 are connected to the input terminal of a differential amplifier 21 consisting of transistors Q8, Q12, Q13, Q14, Q15, and Q16. The input terminal of the differential amplifier 21 is provided by the gate of Q8. A reference voltage is supplied to the gate of Q12 by a circuit 23 consisting of transistors Q9, Q10 and Q11. The circuit 23 is designed to match the characteristics of the combination of a detector transistor Q1, Q2 or Q3, an associated switching transistor Q4, Q5 or Q6, and Q7. Hence, in the illustrative embodiment, the reference transistor Q9 is an NMOS device while Q10 and Q11 are PMOS devices. The reference transistor Q9 is an NMOS transistor with its body tied to its source and is not exposed to light. The voltage applied to the gate of Q9 equals the voltage applied to the gates of Q1, Q2 and Q3. The voltage applied to the gate of Q10 equals the select (enable) voltage applied to the gates of Q4, Q5 and Q6.

The differential amplifier 21 outputs a signal equal to the difference between the reference voltage applied to the gate of Q12 and the voltage sensed by the detectors applied to the gate of Q8 at the source thereof. The output of the differential amplifier is provided via an output driver 25. In practice, the output of the amplifier 21 would typically be digitized via an analog-to-digital converter (not shown) to convert the signal to digital data.

FIG. 3 is a sectional side view showing a portion of the detector array of the imaging system of the present invention on a physical substrate with a color filter thereon. The array 13 is segmented into plural sets of three detector elements 31, 33, 35, each having a detector transistor dedicated to the detection of light of a predetermined color (red, yellow, blue, respectively) for a given picture element (pixel) 29. The array 13 is mounted on a first side 31 of a transparent substrate 27. The substrate 27 may be sapphire in SOS wafers, quart or glass in SOI wafers, or other suitably transparent material.

Plural sets of color filters, one for each pixel 29, are disposed on a second side 37 of the substrate 27. Light of a predetermined color is directed to a photodetector 31, 33, 35 by an associated filter 29′ mounted on the second side 35 of the substrate 27. The first filter 41 is a red filter and may be implemented with red dyed polyimide or other suitable material. The second filter 43 is a yellow filter and may be implemented with yellow dyed polyimide or other suitable material. The third filter 45 is a blue filter and may be implemented with blue dyed polyimide or other suitable material. Those skilled in the art will appreciate that the present invention is not limited to the colors associated with the detector elements and the filters associated therewith. The first and second filter elements 41 and 43 for each filter 29′ may be applied with first and second film layers 47 and 49 respectively.

The color filter can be formed as follows:

1) Coat the back of the finished SOS-CMOS wafer with a layer of polymer that has been dyed with the appropriate color dye. Protect the area that covers the transistors that were dedicated to the red color using photolithography. Etch the rest of the film away using reactive ion etching technique.

2) Coat the back of the wafer with a layer of spin-on-glass to be used as a stop-etch layer.

3) Coat the back of the wafer with a layer of polymer that has been dyed with yellow color dye. Repeat step 4 and 5 to define the yellow color detectors.

4) Coat the back of the wafer with a layer of polymer that has been dyed with blue color dye. Repeat step 4 to define the blue color detector.

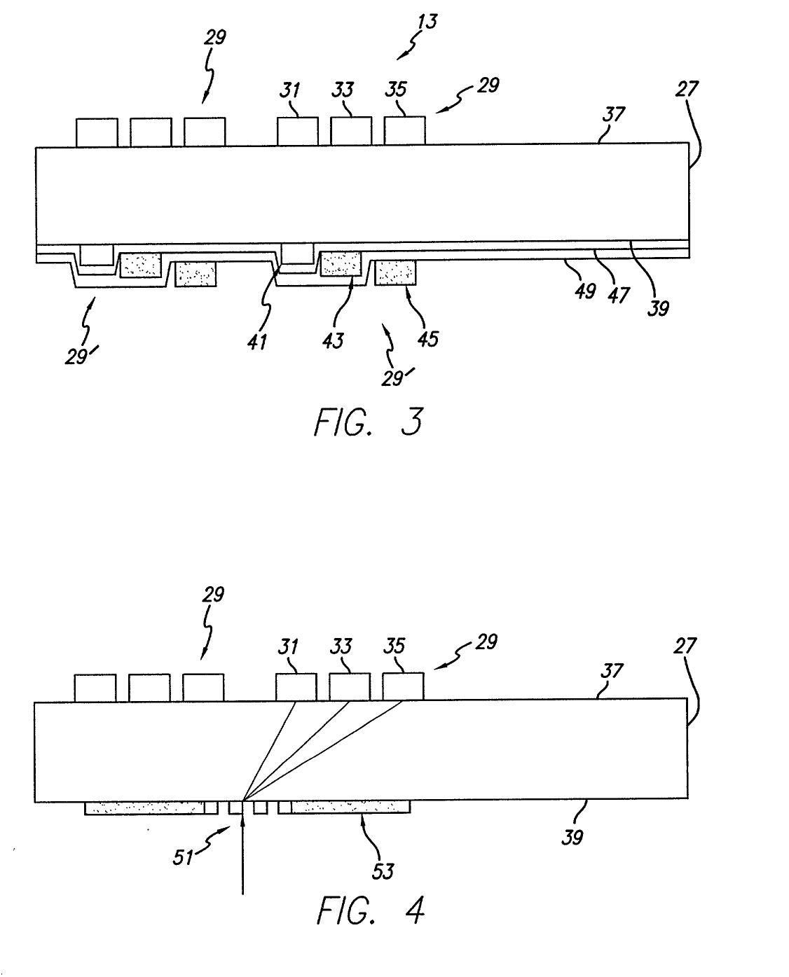

FIG. 4 is a sectional side view of an alternative arrangement for effecting color filtering using a diffractive grating instead of film. The alternative embodiment of FIG. 4 is identical to the embodiment of FIG. 3 with the exception that the color filters are replace with a grating 51. The grating is provided on the second side 39 of the transparent substrate 27. The grating 51 diffracts light of a predetermined color to an appropriate photodetector as depicted in FIG. 4. The grating can be fabricated by:

1) Sputtering metal on to the backside and using lithography to open a window for light detection.

2) Etching a grating inside the transparent window to diffract different color light to different angles. It is desirable to use a slanted grating to increase the diffraction efficiency of the light to the first order. (A plastic grating film can also be used by bonding it to the backside of the wafers.)

The imager 11 can be illuminated from the top or the bottom but the bottom illumination is more efficient since the gate and metal interconnects on top might prevent some light from reaching the detector (body) region of the transistors. For bottom illumination, the transparent substrate should be used.

The imager may be fabricated using standard CMOS on silicon on sapphire (SOS) or silicon on insulator (SOI) wafers and standard fabrication techniques. The SOI wafer can be either glass or quart formed by wafer bonding techniques. After the imager is built, the backside of the wafer should be polished to a predetermined thickness.

Those skilled in the art will appreciate that the inventive imager 11 is similar to a CMOS ROM in structure and operation. In operation, each bit of data is accessed using the word and bit lines, where 2 NMOS transistors will form one bit of data. That is, the transistor being accessed is turned on by applying voltages to the gates of two transistors (e.g. Q1 and Q4). This allows for high density and high operating speeds with random or sequential access under control of software running on the controller.

After accessing a given detector, the transistors are turned off thus no longer responding to light. The phototransistors do not respond to light without gate bias. Thus the gate bias voltage provides a natural shuttering function and the imager 11 does not require a shutter.

Calibration on a pixel by pixel basis can be performed prior to displaying data by adding or subtracting a correction factor stored in a memory.

Thus, the present invention has been described herein with reference to a particular embodiment for a particular application. Those having ordinary skill in the art and access to the present teachings will recognize additional modifications, applications and embodiments within the scope thereof.

It is therefore intended by the appended claims to cover any and all such applications, modifications and embodiments within the scope of the present invention.

Accordingly,

What is claimed is:

1. A detector comprising:
a transistor sensitive to electromagnetic energy and
means for biasing said transistor whereby an output thereof is responsive to said electromagnetic energy.

2. The invention of claim 1 wherein said electromagnetic radiation is light.

3. The invention of claim 2 wherein said light is in the visible portion of the electromagnetic spectrum.

4. The invention of claim 1 wherein said transistor has a body, a gate terminal, a source terminal and a drain terminal.

5. The invention of claim 4 wherein the body of said transistor is configured to float.

6. The invention of claim 5 wherein said transistor is a complementary metal-oxide semiconductor transistor.

7. The invention of claim 6 wherein said transistor is an n-channel complementary metal-oxide semiconductor transistor.

8. The invention of claim 7 wherein said the transistor is formed on top of an insulating substrate which is transparent to visible light.

9. An imager comprising:
first means for detecting input illumination, said first means including an array of detectors, each detector including a transistor sensitive to electromagnetic radiation;
second means for biasing said transistors; and
third means for detecting an output from each of said biased detectors in response to electromagnetic radiation.

10. The invention of claim 9 wherein each of said transistors has a body, a gate terminal, a source terminal and a drain terminal.

11. The invention of claim 10 wherein the body of each transistor is configured to float.

12. The invention of claim 11 wherein each transistor is a complementary metal-oxide semiconductor transistor.

13. The invention of claim 12 wherein each transistor is an n-channel complementary metal-oxide semiconductor transistor.

14. The invention of claim 13 wherein said the transistor is formed on top of an insulating substrate which is transparent to visible light.

15. The invention of claim 9 wherein said second means includes means for selectively activating said transistors.

16. The invention of claim 15 wherein said means for selectively activating includes means for sequentially activating said transistors.

17. The invention of claim 15 wherein said means for selectively activating includes means for randomly activating said transistors.

18. The invention of claim 9 wherein said third means includes a differential amplifier.

19. The invention of claim 18 wherein said amplifier is a current sense differential amplifier.

20. The invention of claim 19 wherein said third means further includes means for supplying a reference voltage to said current sense differential amplifier.

21. The invention of claim 9 wherein said electromagnetic radiation is light.

22. The invention of claim 21 wherein said light is in the visible portion of the electromagnetic spectrum.

23. The invention of claim 22 further including means for mounting a first color filter between said light and one or more of a first set of said detectors.

24. The invention of claim 23 further including means for mounting a second color filter between said light and one or more of a second set of said detectors.

25. The invention of claim 24 further including means for mounting a third color filter between said light and one or more of a third set of said detectors.

26. The invention of claim 22 further including a grating for directing light of a first color to one or more of a first set of said detectors.

27. The invention of claim 26 wherein said grating is adapted to direct light of a second color to one or more of a second set of said detectors.

28. The invention of claim 27 wherein said grating is adapted to direct light of a third color to one or more of a third set of said detectors.

29. An imager comprising:
first means for detecting input illumination, said first means including an array of detectors, each detector including an n-channel complementary metal-oxide semiconductor transistor sensitive to electromagnetic radiation, each of said transistors having a body configured to float;
second means for biasing, selectively and sequentially activating said transistors; and
third means for detecting an output from each of said biased detectors in response to electromagnetic radiation, said third means including a differential amplifier.

30. The invention of claim 29 wherein said amplifier is a current sense differential amplifier.

31. The invention of claim 30 wherein said third means further includes means for supplying a reference voltage to said current sense differential amplifier.

32. The invention of claim 29 wherein said electromagnetic radiation is light.

33. The invention of claim 32 wherein said light is in the visible portion of the electromagnetic spectrum.

34. The invention of claim 33 further including means for mounting a first color filter between said light and one or more of a first set of said detectors.

35. The invention of claim 34 further including means for mounting a second color filter between said light and one or more of a second set of said detectors.

36. The invention of claim 35 further including means for mounting a third color filter between said light and one or more of a third set of said detectors.

37. The invention of claim 33 further including a grating for directing light of a first color to one or more of a first set of said detectors.

38. The invention of claim 37 wherein said grating is adapted to direct light of a second color to one or more of a second set of said detectors.

39. The invention of claim 38 wherein said grating is adapted to direct light of a third color to one or more of a third set of said detectors.
